(19) United States
(12) Patent Application Publication
(10) Pub. No.: US 2017/0199387 A1
(43) Pub. Date: Jul. 13, 2017

(54) Optical Device For Redirecting Field of Vision

(71) Applicant: Kenneth Elmon Koch, III, Waxhaw, NC (US)

(72) Inventor: Kenneth Elmon Koch, III, Waxhaw, NC (US)

(21) Appl. No.: 15/399,932

(22) Filed: Jan. 6, 2017

Related U.S. Application Data
(60) Provisional application No. 62/387,864, filed on Jan. 8, 2016.

(51) Int. Cl. G02B 27/02; G02B 7/182; G02B 17/02

(52) U.S. Cl. CPC G02B 27/022; G02B 17/02; G02B 27/028; G02B 7/1824

(57) ABSTRACT

A wearable optical device, wherein the device is comprised of a center chamber, containing two mirrors or highly reflective surfaces, and two temple pieces and enables the user to view objects at a varying downward angle incident to their normal forward line-of-sight. The device restricts the wearer's forward line-of-sight to that of the reflected image. In addition, the device allows for the adjustment of the viewing angle as well as the length of the temple pieces for optimal viewing angle and comfort.

### CROSS-REFERENCE TO RELATED APPLICATIONS

This non-provisional patent application claims the benefit of U.S. Provisional Patent Application No. 62/387,864, filed Jan. 8, 2016.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to an optical device that is used to redirect a user's line of sight in a downward direction relative to their forward line of sight. Excessive reading and viewing of media can result in neck pain caused by a tendency to lean the head forward and down, closer to the material being viewed. The present invention is intended to allow users to view media, including books, television, computer screens, and mobile devices, while keeping their head in a neutral position and looking straight ahead into the device, thereby reducing or eliminating neck pain and fatigue. The present invention permits the user to read a book on a table or on their lap with the head in an upright position. It also allows the user to watch television or read while lying flat or at varying angles. Prior art has addressed this problem through the use of prisms and/or mirrors. Solutions using prisms present problems for the users due to the weight of the prisms. In order to reduce the weight, separate prisms are used, which can result in eye fatigue. For prior art that uses mirrors to redirect users' vision, the solutions entail the use of one or two mirrors. In the former case, the use of a single mirror results in the image being reversed, rendering text unreadable. In the latter case, solutions are either non-wearable or multi-imaged in which the user is able to view the reflected image and a portion of their forward line-of-sight simultaneously. This simultaneous viewing can become very distracting and fatiguing to the eyes.

The present invention is a lightweight, wearable device that uses two mirrors, with an adjustable angle, to redirect the user's vision while restricting all forward line-of-sight vision to the image reflected by the mirrors.

The following applications were referenced as a part of the initial patent search:

| Patent Number | | Date | Inventor | Classification |
|---|---|---|---|---|
| 8,186,828 | B2 | May 2012 | Leeper | 351/159.58 |
| 6,280,031 | B1 | August 2001 | Zerkle | 351/158 |
| 5,042,910 | | August 1991 | Dolezal | 350/145 |
| 7,494,219 | B2 | February 2009 | Shahkarami | 351/158 |
| 2,123,682 | | July 1936 | Wingate | 359/480 |
| 4,077,703 | | March 1978 | Pablo | 359/480 |
| 7,542,204 | B2 | June 2009 | Fante et al. | 359/411 |
| 8,917,459 | B2 | December 2014 | Klein et al. | 359/743 |
| 4,804,261 | | February 1989 | Kirschen | 351/158 |
| 6,010,225 | | January 2000 | Lerner et al. | 359/872 |
| 8,561,990 | | October 2013 | Benson | 273/150 |
| 6,609,802 | B1 | August 2003 | Majax | 359/879 |
| 6,106,123 | | August 2000 | McDonald | 359/872 |
| 5,760,865 | | June 1998 | Webster | 351/41 |
| 8,979,285 | B1 | March 2015 | Sasaki | 359/842 |
| 5,422,759 | | June 1995 | Lee | 359/857 |
| 5,173,720 | | December 1992 | Lee et al. | 351/50 |

U.S. Pat. No. 8,186,828 to Leeper shows a pair of prism glasses with moveable lenses and detachable temples. U.S. Pat. No. 6,280,031 to Zerkle shows a pair of prism viewing glasses. U.S. Pat. No. 5,042,910 to Dolezal shows a pair of goggles integrated with an adjustable prism. U.S. Pat. No. 7,494,219 to Shahkarami shows a pair of prism glasses with an adjustable angle between the body of the glasses and the temple pieces. U.S. Pat. No. 2,123,682 to Wingate describes a pair of glasses utilizing prisms with an adjustable angle at the temples. U.S. Pat. No. 4,077,703 to Pablo describes a pair of prism glasses that partially reflect, allowing the user to simultaneously see a reflected image and their regular, line-of-sight view, superimposed on each other. U.S. Pat. No. 7,542,204 to Fante et al. shows a pair of glasses that use specialized prisms to alter the angle of a surgeon's vision for downward viewing. U.S. Pat. No. 8,917,459 to Klein et al. shows a pair of angle adjusting glasses that use a Fresnel prism to alter the viewing angle of the wearer.

The Leeper, Zerkle, Dolezal, Shahkarami, Wingate, Pablo, Fante et al., and Klein et al. patents, described above, all utilize solid prisms, in various positions and embodiments to change the viewing angle of the wearer's vision.

U.S. Pat. No. 4,804,261 to Kirschen describes a pair of goggles that use a single mirror to redirect the user's vision outside of a confined space, such as an MRI machine. This device produces a mirror, or reverse, image.

U.S. Pat. No. 6,010,225 to Lerner et al. describes a tabletop viewing device, using mirrors, upon which an eye surgery patient rests his or her head to maintain a downward facing position. The patient's vision is then directed upward from their normal line of sight.

U.S. Pat. No. 8,561,990 to Benson shows a playing card reader device that utilizes two opposing mirrors to view playing cards that are inserted into the device. The image is restricted to the area in the device into which the cards are inserted.

U.S. Pat. No. 6,609,802 to Majax describes a single mirror device that directs the wearer's vision upward for nighttime sky viewing. This device produces a mirror, or reverse, image.

U.S. Pat. No. 6,106,123 to McDonald shows an opthalmic recovery device similar to that of Lerner et al. that includes sides for blocking ambient light. U.S. Pat. No. 5,760,865 to Webster shows a dual surface device that allows the user to simultaneously view a straight ahead image and a reflected image that is relative to the user's upward line of sight.

U.S. Pat. No. 8,979,285 to Sasaki shows a device that attaches to a bicycle and utilizes a single mirror to redirect a users vision upward relative to their line of sight. This device produces a mirror, or reverse, image.

U.S. Pat. No. 5,422,759 to Lee shows a device that that utilizes two opposing mirrors to direct the user's vision in a downward angle. The device is intended to be strapped to the users head or attached to a pair of eyeglasses. This device does not fully obstruct the forward line-of-sight of the user which results in the simultaneous viewing of objects directly in the line-of-sight in addition to the image being reflected by the mirrors.

U.S. Pat. No. 5,173,720 to Lee et al. describes a pair of vision directing glasses utilizing two adjustable angle mirrors. This device is similar to Lee, above, in that it also allows the user to simultaneously view objects directly in their line-of-sight in addition to the image being reflected by the mirrors

### BRIEF SUMMARY OF THE INVENTION

The present invention is a wearable device with two adjustable angle mirrors that permit the wearer to view objects that are 60 to 90 degrees beneath their forward line of vision while preventing them from viewing objects directly in front or to the sides of them. In addition, the present invention is worn similarly to eyeglasses and has adjustable temple pieces to accommodate users of varying head size. It permits the user to read or watch various forms of media while keeping their head in a neutral, non-leaning position.

### BRIEF DESCRIPTION OF DRAWINGS

FIG. 1 is a depiction of the user's redirected line-of-sight when using the present invention;

FIG. 2 is a diagram of the left front temple piece as viewed from the side that faces the inside of the device;

FIG. 3 is a diagram of the left front temple piece as viewed from the side that faces the outside of the device;

FIG. 4 is a diagram of the left rear temple piece as viewed from the side that faces the inside of the device;

FIG. 5 is a diagram of the left rear temple piece as viewed from the side that faces the outside of the device;

FIG. 6 is a diagram of the assembled left temple piece as viewed from the side that faces the inside of the device;

FIG. 7 is a diagram of the assembled left temple piece as viewed from the side that faces the outside of the device;

FIG. 8 is a diagram of the right front temple piece as viewed from the side that faces the inside of the device;

FIG. 9 is a diagram of the right front temple piece as viewed from the side that faces the outside of the device;

FIG. 10 is a diagram of the right rear temple piece as viewed from the side that faces the inside of the device;

FIG. 11 is a diagram of the right rear temple piece as viewed from the side that faces the outside of the device;

FIG. 12 is a diagram of the assembled right temple piece as viewed from the side that faces the inside of the device;

FIG. 13 is a diagram of the assembled right temple piece as viewed from the side that faces the outside of the device;

FIG. 14 is a diagram of the center chamber of the device;

FIG. 15 is a diagram of the center chamber of the device in a partially folded state;

FIG. 16 is a diagram of the center chamber of the device in a fully folded state;

FIG. 17 is a diagram of the fully assembled device consisting of both temple pieces and the center chamber; and

FIG. 18 is a diagram of the fully assembled device consisting of both temple pieces and the center chamber, as viewed from the right side.

### DETAILED DESCRIPTION OF THE INVENTION

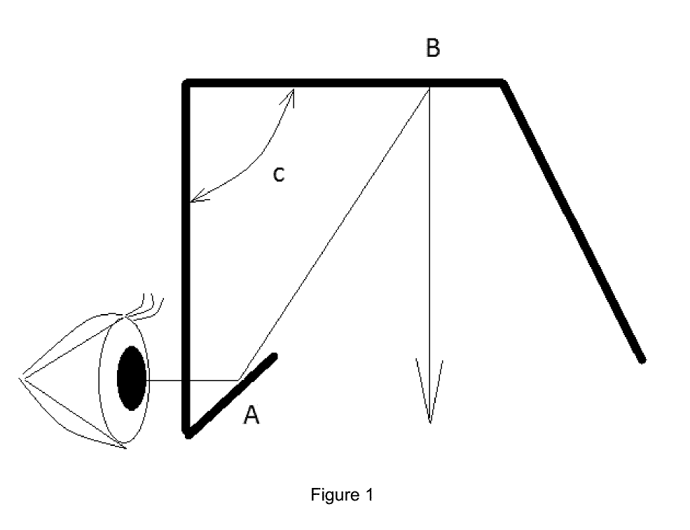

In an effort to alleviate neck and eye fatigue, the present invention is a wearable device that redirects the user's vision in an adjustable downward angle, as depicted in FIG. 1. The angle of the redirection may be changed by varying angle C (FIG. 1).

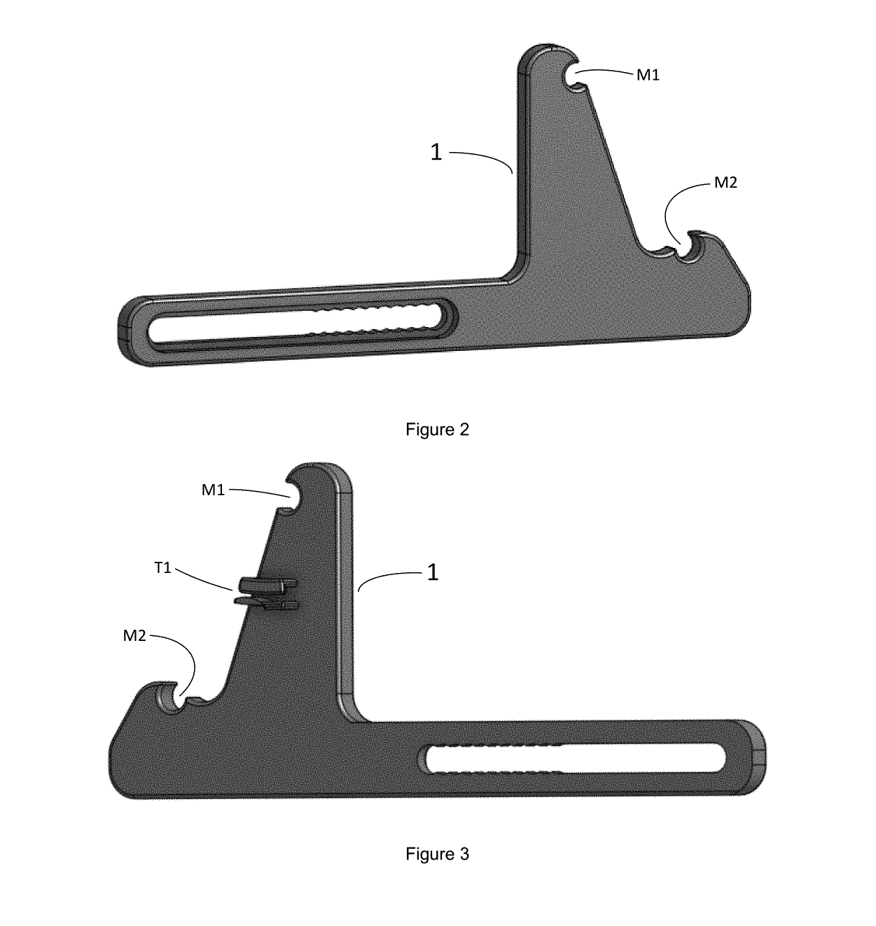

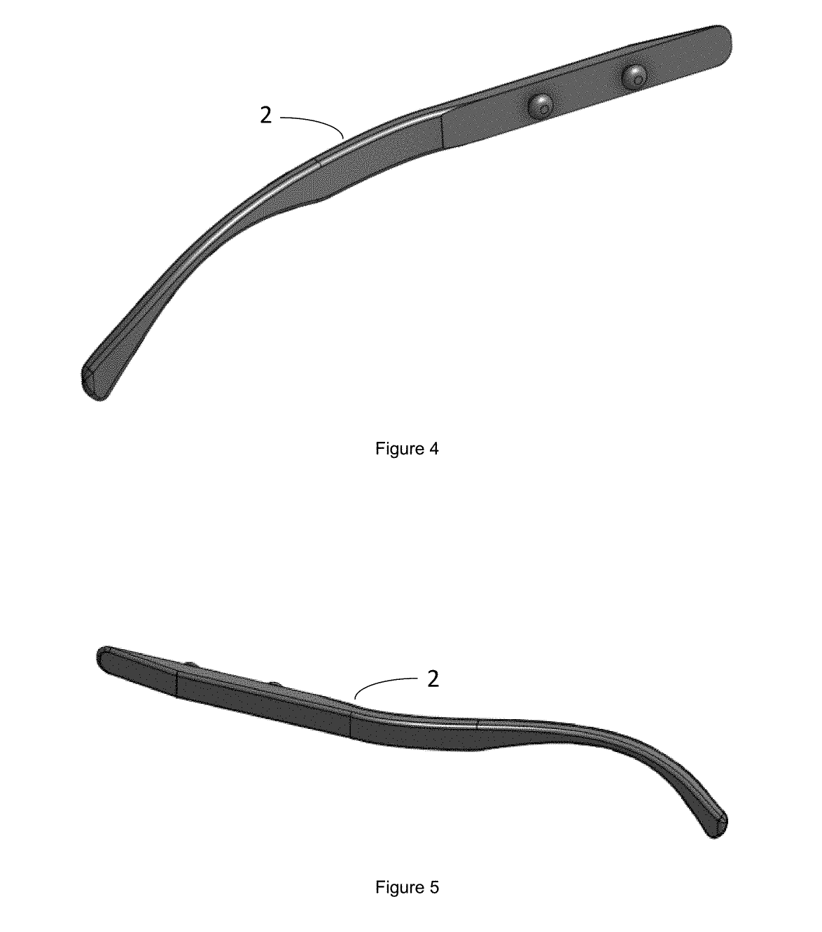

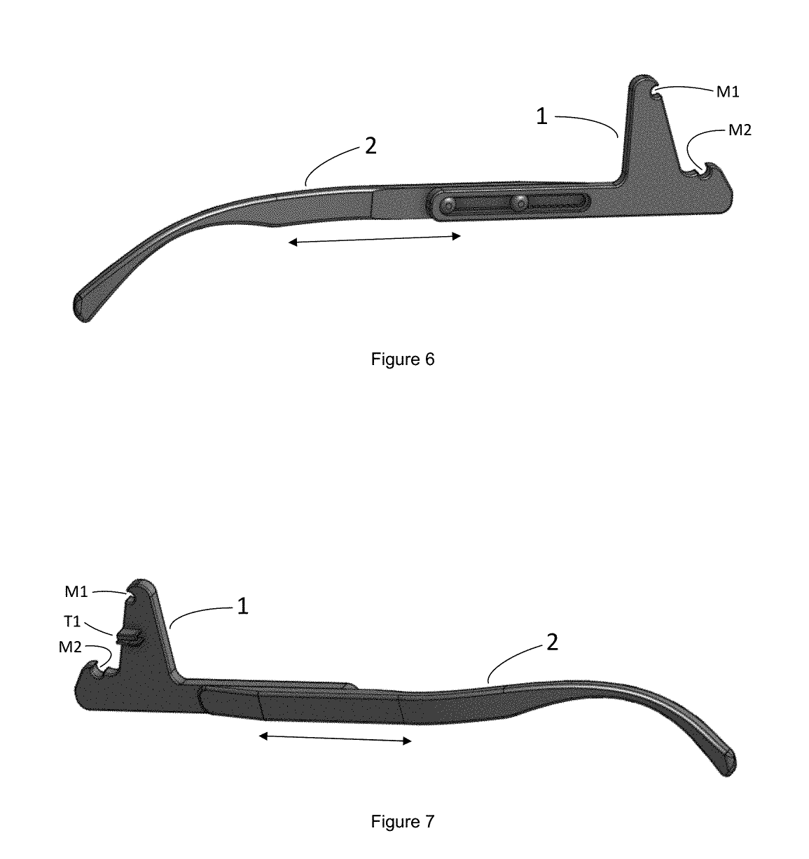

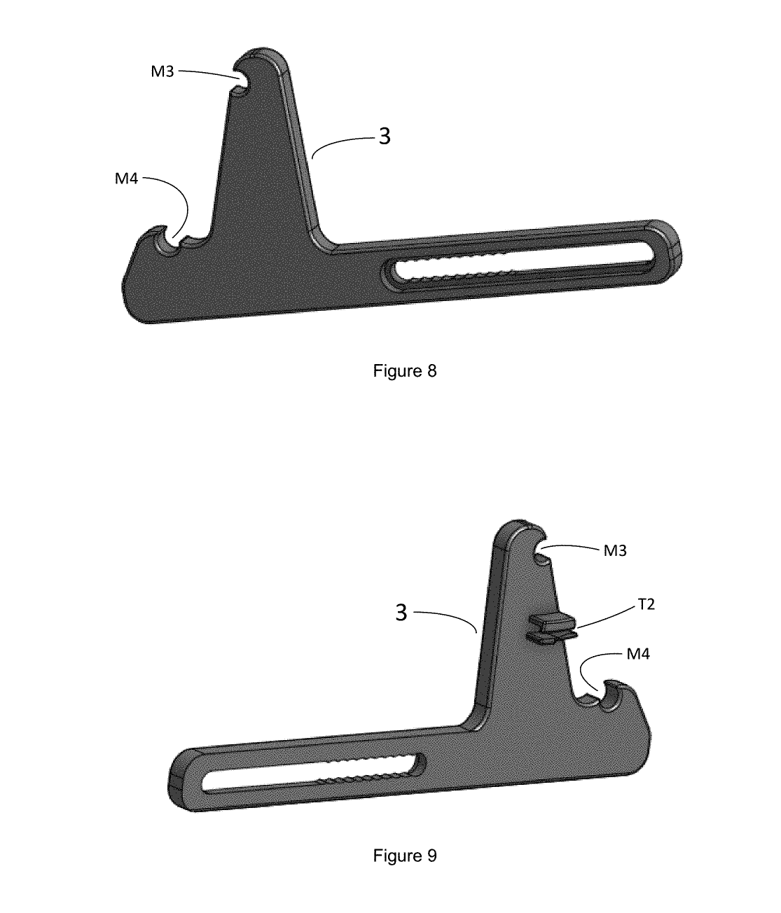

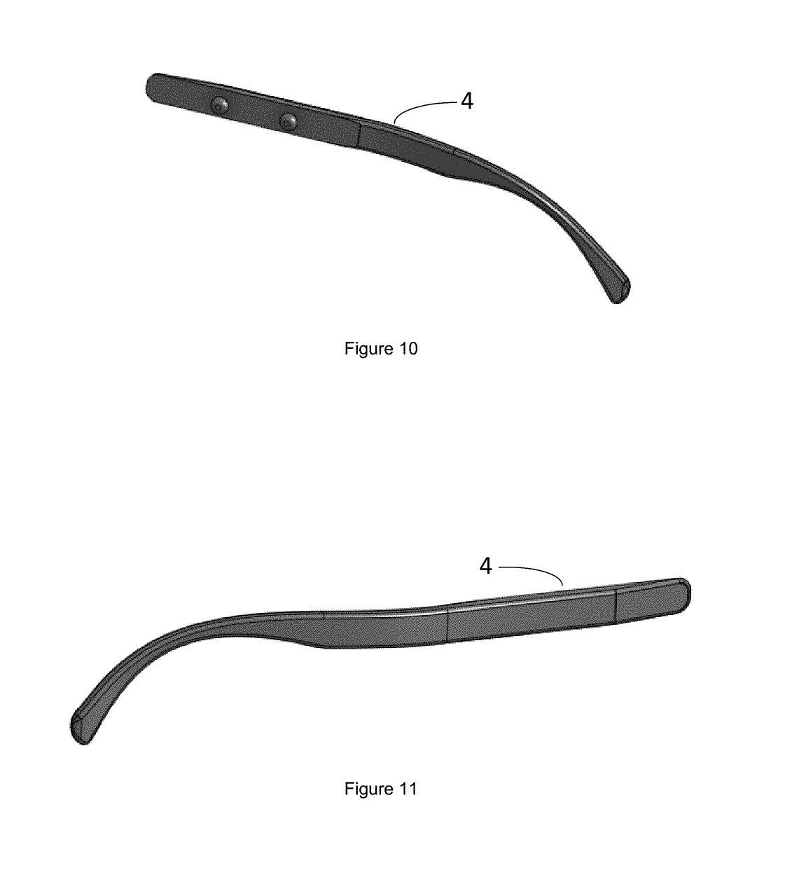

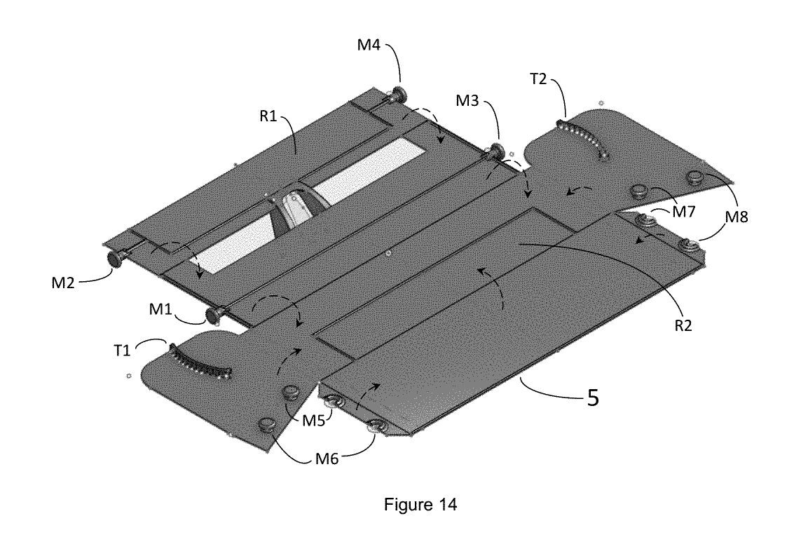

The device consists of seven parts:
a left front temple piece, as depicted in FIGS. 2 and 3;
a left rear temple piece, as depicted in FIGS. 4 and 5;
a right front temple piece, as depicted in FIGS. 6 and 7;
a right rear temple piece, as depicted in FIGS. 8 and 9;
a center chamber, as depicted in FIGS. 14, 15, and 16;
two highly reflective surfaces, preferably mirrors.

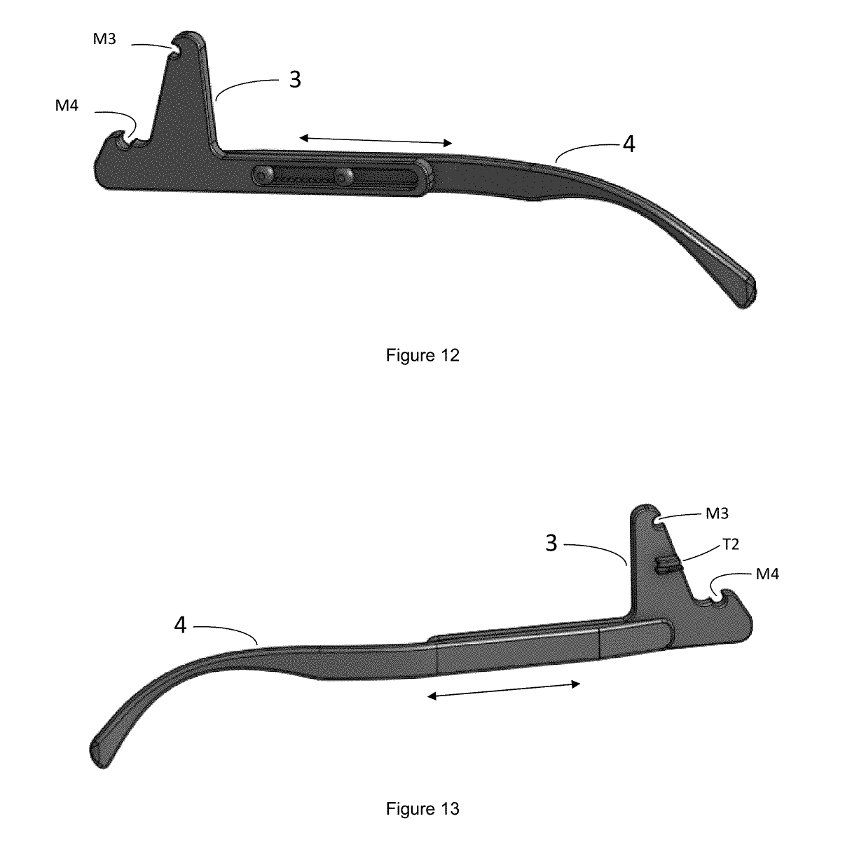

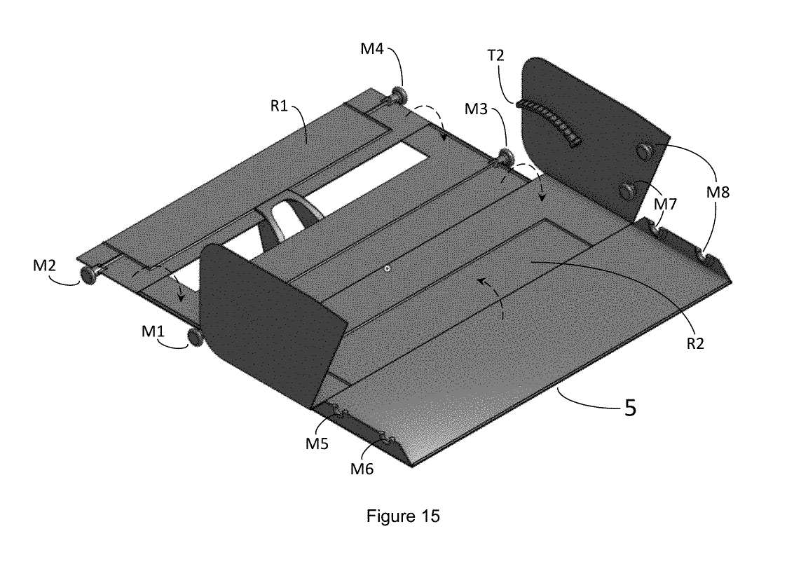

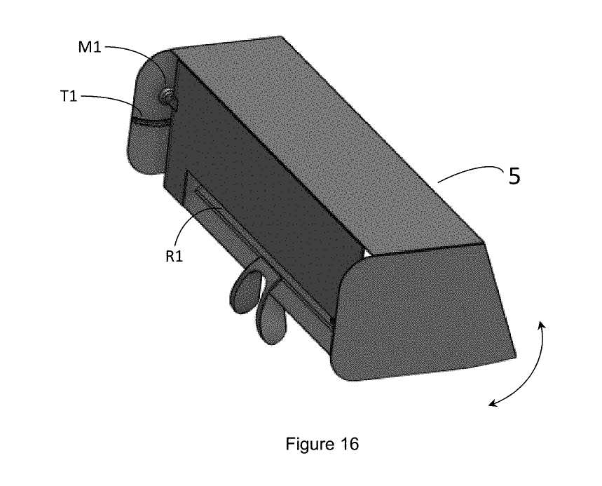

The device is assembled by snapping the posts on the rear temple pieces into the tracks on the corresponding front temple pieces to form the left and right temple assemblies, as shown in FIGS. 6 and 7 (left temple assembly) and FIGS. 12 and 13 (right temple assembly). The center chamber, which is intended to be molded into a flat piece and then folded into its assembled form, accepts mirrors, or other reflective surfaces, in regions R1 and R2, as shown in FIG. 14. The mate points shown in FIGS. 14 (M5, M6, M7, and M8) are then snapped together to form the chamber that limits the user's forward vision to that of the reflected image (FIG. 15). The center chamber is then folded into its final form, as shown in FIG. 16.

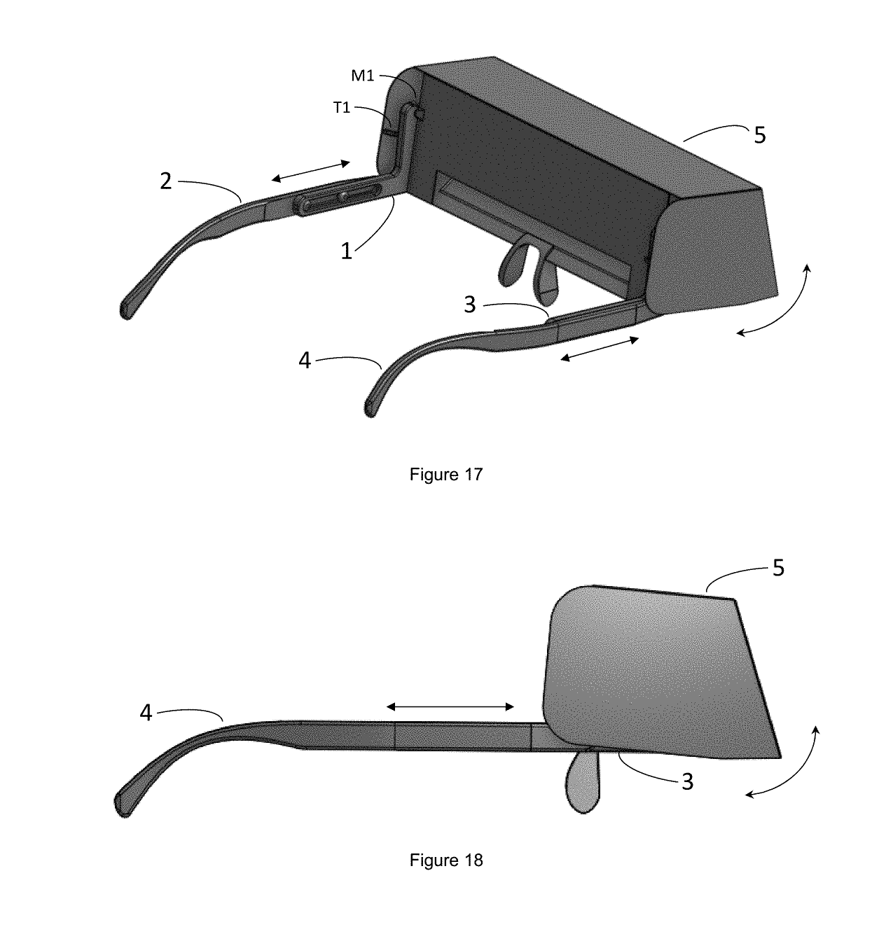

The final assembly of the device is completed via the attachment of the temple pieces to the center chamber by matching the corresponding mate points (M1, M2, M3, and M4) and snapping the temple pieces to the center chamber, as shown in FIG. 17. Additionally, the tracks on the sides of the center chamber (T1 and T2) are positioned to slide through the corresponding guides (T1 and T2) on their respective temple pieces. These guides (T1 and T2) are shown in FIGS. 3 and 7 for the left temple piece and FIGS. 9 and 13 for the right temple piece. Each guide is designed with a point that is narrower than the thickness of the track on the center chamber. This provides a means for each track to ratchet through the guide, thereby providing multiple “stopping” points and providing the means for varying the angle of the upper mirror (at location R2) and keeping it fixed at the desired viewing angle.

The lengths of the right and left temple assemblies are adjusted by sliding each rear temple piece in the track of the corresponding front temple piece to which it is attached. The tracks in the front temple pieces contain grooves that provide “stopping” points for fixing the temples at the desired length.

In another embodiment of the device, the inventor envisions a version in which the center chamber and temple pieces are formed into a single, integrated component that is folded into a structure similar to the structure shown in FIG. 17.

In another embodiment of the device, the inventor envisions the reflective surfaces being repositioned to redirect the user's line of sight in either an upward direction or to one side while retaining the perspective of the reflected image as if the objects being reflected were directly in front of the wearer (i.e. not a “mirror” or reversed image).

What is claimed is:

1. A wearable device for redirecting the wearer's vision, comprising:
a center chamber containing two reflective surfaces, wherein one surface redirects the wearer's line of sight to the second reflective surface that provides an additional redirection to the image being viewed outside of the chamber; and said device restricts the wearer's forward looking line-of-sight to the image produced by the reflection;
a right temple piece with an adjustable length;
a left temple piece with an adjustable length;
a nose piece that is either an integrated component of the center chamber or a separate component that is attached to the center chamber.

2. The device of claim 1, wherein the angle of one or both reflective surfaces is adjustable via an increase or decrease in the folding angles of the chamber to which the reflective surfaces are attached.

3. The device of claim 1, wherein the angle of one or both reflective surfaces is adjustable via hinges or other mechanisms to which one or both of the reflective surfaces is directly or indirectly attached.

4. The device of claim 1, wherein the temple pieces are replaced with a strap for securing the center chamber to the wearer's face and head.

5. The device of claim 1, wherein the center chamber is comprised of a single piece of material that is molded flat and subsequently folded or assembled into a final working configuration or molded directly into the final working configuration.

6. The device of claim 1, wherein the center chamber and temple pieces are integrated in a single piece of material that is subsequently folded or assembled into a final working configuration or molded directly into the final working configuration.

7. The device of claim 1, wherein the center piece consists of multiple components that are assembled to form its final working configuration.

8. The device of claim 1, wherein the temples components are of fixed length.

9. The device of claim 1, wherein its dimensions allow it to be worn over conventional eyeglasses.
